(19) United States
(12) Patent Application Publication
(10) Pub. No.: US 2020/0005084 A1
(43) Pub. Date: Jan. 2, 2020

(54) TRAINING METHOD OF, AND INSPECTION SYSTEM BASED ON, ITERATIVE DEEP LEARNING SYSTEM

(71) Applicant: UTECHZONE CO., LTD., New Taipei City (TW)

(72) Inventors: ARULMURUGAN AMBIKAPATHI, New Taipei City (TW); CHIEN-CHUNG LIN, New Taipei City (TW); CHENG-HUA HSIEH, New Taipei City (TW)

(21) Appl. No.: 16/458,772

(22) Filed: Jul. 1, 2019

(30) Foreign Application Priority Data
Jul. 2, 2018 (TW) 107122849

(51) Int. Cl. G06K 9/62

(52) U.S. Cl. CPC G06K 9/6256; G06K 9/6262

(57) ABSTRACT

A training method of an iterative deep learning system, comprising the steps of: providing at least one unlabeled image of an object; labeling the unlabeled image of the object to produce a labeled image of the object; storing the labeled image of the object into an image database if the deep learning system is being trained with a labeled version of the unlabeled image of the object for a first time; identifying the labeled image of the object in the image database and outputting an identification result through the deep learning system; and training the deep learning system according to an error between output and expected output of the identification result; and providing another unlabeled image of the object to the trained deep learning system to identify said another unlabeled image of the object and to produce an inspection result; wherein determining whether the inspection result has satisfied a qualification condition and terminating training if the inspection result has satisfied the qualification condition.

### BACKGROUND OF THE INVENTION

### 1. Technical Field

The present invention relates to a method for training a deep learning system and an inspection system based on the deep learning system. More particularly, the invention relates to a training method of, and an inspection system based on, an iterative deep learning system, wherein the training method can effectively lower the skip rate (i.e. missing detection rate), and lead to good and stably convergent results, of the iterative deep learning system and hence of the inspection system.

### 2. Description of Related Art

As a branch of machine learning, deep learning refers to algorithms by which to perform feature learning on data. Basically, deep learning is a process in which data is processed and analyzed through multiple processing layers, the objective being to establish an artificial neural network analogous to the human brain in terms of reasoning, knowledge, planning, learning, data exchange, sensing, moving, and object operation so that data can be processed and analyzed via a working mechanism that simulates the human brain. Advantageously, a deep learning algorithm can be used in place of human operation, and some notable examples of deep learning applications are image recognition and speech recognition.

Furthermore, deep learning systems have found extensive use in optical inspection. With the help of artificial neural networks, human selection is no longer required in the machine training process of optical inspection machines. Strong hardware performance and powerful algorithms make it possible to input images directly into an artificial neural network so that a machine can learn on its own to inspect and identify objects.

The first and most important stage of machine learning is training. During the training (i.e., data processing and analyzing) process, however, the parameters, model. structures, or other factors of a deep learning algorithm tend to result in a skip rate that is difficult to lower, and an identification accuracy rate that cannot be effectively maintained. Consequently, training errors take place, and convergence is not guaranteed, both of which work against the goal of improving the performance (e.g., inspection accuracy) of the deep learning system.

### BRIEF SUMMARY OF THE INVENTION

The primary objective of the present invention is to train a deep learning system in an iterative manner so as to produce good and stably convergent results, lower the skip rate effectively, and thereby raise the accuracy of an inspection system based on the deep learning system.

In order to obtain the above objective, the present invention provides a training method of an iterative deep learning system, comprising the steps of: a) providing at least one unlabeled image of an object; b) labeling the unlabeled image of the object to produce a labeled image of the object; c) storing the labeled image of the object into an image database if the deep learning system is being trained with a labeled version of the unlabeled image of the object for a first time; d) identifying the labeled image of the object in the image database and outputting an identification result, through the deep learning system; and training the deep learning system according to an error between output and expected output of the identification result; and e) providing another unlabeled image of the object to the trained deep learning system to identify said another unlabeled image of the object and produce an inspection result; determining whether the inspection result has satisfied a qualification condition; and terminating training if the inspection result has satisfied the qualification condition, or repeating the steps a) to e) if the inspection result has not satisfied the qualification condition.

In order to obtain the above objective, the present invention provides an inspection system based on iterative deep learning, comprising: a labeling device for receiving and then labeling at least one unlabeled image of an object to produce a labeled image of the object; an image storage unit for storing the labeled image of the object into an image database; and a processor loaded with a deep learning system and configured to perform the above method after loading data from a non-transitory recording medium.

Comparing to the conventional techniques, the present invention has the following advantages:

1. The present invention provides a training method of, and an inspection system based on, an iterative deep learning system. The training method involves training iteratively until the inspection result satisfies the qualification condition. This makes it easier for the inspection results generated in the training process to converge; and for the inspection system to have a high identification accuracy rate.

2. The training method and inspection system of the present invention allow erroneous classification results to be analyzed with ease. More specifically, the classification result of each defect is checked against a database to ascertain the cause of any erroneous classification.

### BRIEF DESCRIPTION OF THE SEVERAL VIEWS OF THE DRAWINGS

FIG. 1 is a block diagram of an iterative deep learning-based inspection system according to the present invention.

FIG. 2 is a flowchart of the training method of an iterative deep learning system according to the present invention.

FIG. 3-1 is a plot showing the skip rates of the first set of experiment data of the training method of the present invention.

FIG. 3-2 is a plot showing the false defect filtering rates of the first set of experiment data of the training method of the present invention.

FIG. 4-1 is a plot showing the skip rates of the second set of experiment data of the training method of the present invention.

FIG. 4-2 is a plot showing the false defect filtering rates of the second set of experiment data of the training method of the present invention

### DETAILED DESCRIPTION OF THE INVENTION

The details and technical solution of the present invention are hereunder described with reference to accompanying drawings. For illustrative sake, the accompanying drawings are not drawn to scale with emphasized appearance. The accompanying drawings and the scale thereof are not intended to be restrictive of the scope of the invention.

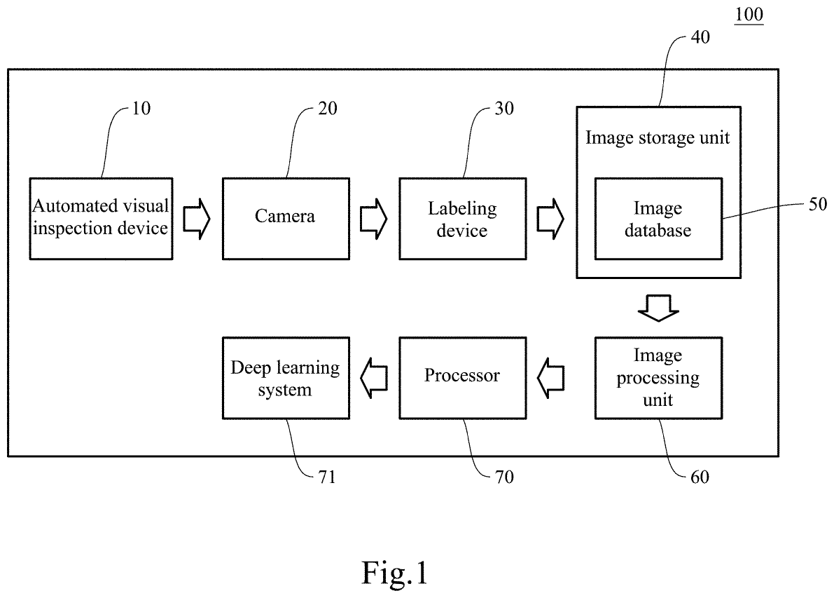

Please refer to FIG. 1 for a block diagram of an iterative deep learning-based inspection system according to the present invention.

The present invention discloses an inspection system 100 based on iterative deep learning. The inspection system 100 includes the equipment required for training a deep learning system iteratively, i.e., the training process will repeat itself until the performance of the deep learning system satisfies the qualification condition. The disclosed inspection system 100 can produce good and stably convergent results and is effective in lowering the skip rate and raising the false defect filtering rate (i.e. false-positive elimination rate).

The inspection system 101) includes an automated visual inspection device 10, a camera 20, a labeling device 30, an image storage unit 40, an image processing unit 60, and a processor 70 loaded with a deep learning system 71.

The automated visual inspection device 10 is configured to identify any defect of an object under inspection and, once the identification is completed, provide at least one unlabeled image of the object under inspection. To facilitate image recognition and thereby increase the learning efficiency of the deep learning system 71, image enhancement can be carried out through an auxiliary light source or the image processing unit 60.

The camera 20 is provided between the automated visual inspection device 10 and the labeling device 30 to enhance any defect feature in the unlabeled image of the object under inspection. More specifically, the camera 20 is configured to provide proper lighting through a stationary or movable auxiliary light source to the defect features of the object under inspection, take a picture (i.e., a defect-enhanced image) of the object under inspection, and output the defect-enhanced image to the labeling device 30.

The labeling device 30 receives and subsequently labels the at least one unlabeled image of the object under inspection. The unlabeled image may be labeled after review by a visual inspector or after machine inspection; the present invention has no limitation in this regard.

The image storage unit 40 is configured to store the labeled image of the object under inspection into the image database 50. In one preferred embodiment, the image storage unit 40 is a non-transitory computer-readable recording medium for recording images of the object under inspection.

The image processing unit 60 is configured to perform a normalization process on the image labeled by the labeling device 30 and then store the normalized image into an image database 50. The normalization process may include, for example, but is not limited to, extracting standard-size defect images from the labeled image of the object under inspection and adjusting the contrast and brightness of the extracted images to their respective proper levels (or performing an arbitrary image preprocessing procedure on the extracted images); the present invention has no limitation in this regard.

The processor 70 is configured to load data from the image storage unit 40 and then execute the deep learning system 71. When the deep learning system 71 is trained for the first time with a particular unlabeled image of the object under inspection (or more specifically with a labeled version thereof), the processor 70 identifies any defect in the corresponding labeled image of the object under inspection (which image is retrieved from the image database 50), outputs the identification result, and trains the deep learning system 71 according to the difference (i.e., error) between the output identification result and an expected output. Then, the processor 70 provides another unlabeled image (say, a second unlabeled image) of the object under inspection to the trained deep learning system 71 identifies any defect in the corresponding labeled image of the object under inspection, and outputs an inspection result. When the deep learning system 71 is not being trained for the first time with a labeled version of the second unlabeled image of the object under inspection, the processor 70 analyzes whether or not the inspection result has satisfied the qualification condition, and if the inspection result has satisfied the qualification condition, the training procedure will be terminated.

The image storage unit 40, the image database 50, the image processing unit 60, the processor 70, and the deep learning system 71 in the present invention may be provided in a co-constructed configuration or separately; the present invention has no limitation in this regard.

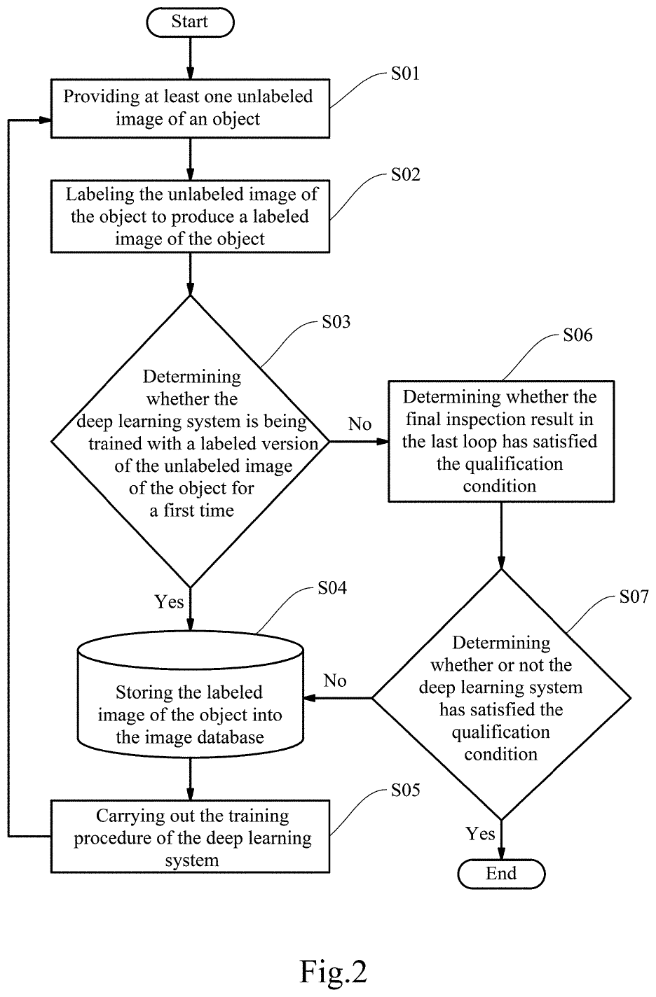

The training method of the foregoing iterative deep learning system is described in more detail below with reference to FIG. 2, which shows the flowchart of the training method of an iterative deep learning system according to the present invention.

The present invention discloses a training method of an iterative deep learning system. The training Method applies the principle of iteration to the training of a deep learning system and trains the deep learning system repeatedly until the performance of the deep learning system satisfies the qualification condition. Multiple test results (provided further below) of a deep learning system trained by the disclosed training method demonstrate that the training method helps produce good and stably convergent results and can effectively lower the skip rate and increase the false defect filtering rate.

The training method essentially includes the following steps:

To start with, a batch of at least one unlabeled image of an object under inspection (hereinafter referred to as the object for short), e.g., a first unlabeled image of the object, is provided (step S01). The first unlabeled image is transmitted to the camera 20, in order for the camera 20 to enhance the defect features in the first unlabeled image of the object.

Next, the at least one unlabeled image (e.g., the first unlabeled image) of the object is labeled (step S02). For example, a visual inspector reviews the first unlabeled image of the object to verify that the defect features in the first unlabeled image of the object corresponds to a defect of the object. Then, the labeling device 30 labels the first unlabeled image to indicate the location of the defect on the object.

Following that, the processor 70 determines Whether or not the deep learning system 71 is being trained with a labeled version of the first unlabeled image of the object for the first time (step S03).

As the deep learning system 71 is trained for the first time with a labeled image derived from the first unlabeled image of the object, the labeled image of the object is stored into the image database 50 (step S04). In one preferred embodiment, the first unlabeled image of the object is labeled by the labeling device 30 and then normalized by the image processing unit 60, before being stored into the image database 50.

The normalized image is subsequently transmitted to the processor 70 in order for the processor 70 to carry out the training procedure of the deep learning system 71 (step S05) as follows. Once the labeled image of the object is input into the deep learning system 71, the deep learning system 71 identifies (i.e., classifies) the defect in the labeled image of the object, outputs an identification result, and is trained through backpropagation according to the error between the output identification result and an expected output (i.e., an expected identification result).

When the training is completed, the process flow returns to step S01, in which the processor 70 provides another batch, e.g., a second batch, of at least one unlabeled image of the object (e.g., a second unlabeled image of the object) to the trained deep learning system 71, in order for the deep learning system 71 to identify any defect in a labeled image derived from the second unlabeled image of the object and output an inspection result. Then, the process flow goes back to steps S01 and S02 to label the inspection result, thereby starting the first iteration. The inspection result (derived from the second unlabeled image of the object) can be subsequently changed to the next batch, e.g., a third hatch, of image(s) to be used for training, but whether or not to train with the third batch of image(s) depends on the result of the following analysis of whether or not the inspection result has satisfied the qualification condition.

When step S03 determines that the deep learning system 71 is not being trained for the first time with a labeled image (e.g., a labeled inspection result) derived from the second unlabeled image of the object, the final inspection result in the last loop will be analyzed to determine whether or not that inspection result has satisfied the qualification condition (step S06). If the aforesaid inspection result has satisfied the qualification condition (step S07), the training procedure will be terminated; otherwise, step S04 will be performed to store the inspection result (i.e., a labeled image derived from the second unlabeled image of the object) into the image database 50 (step S04), followed sequentially by the training procedure of step S05 and the start of the next iteration. The above process will be repeated as needed. It is worth mentioning that the labeled image(s) stored in step S04 may include another batch of at least one image of the object that has been reviewed by a visual inspection engineer or checked by the automated visual inspection device 10, or an erroneously classified sample (i.e., an image of the object) found in the most recent analysis of whether or not the qualification condition has been satisfied. The analysis of whether or not the qualification condition has been satisfied is carried out by comparing an inspection result with the corresponding determination result of a visual inspector in charge of optical inspection so as to obtain the skip rate or the false defect filtering rate. In one preferred embodiment, the training procedure is terminated when the number of days of training exceeds a predetermined number without the qualification condition being satisfied. The qualification condition may demand that the skip rate and/or the false defect filtering rate reach a preset standard for a predetermined number of consecutive days. For example, one preferred embodiment requires the skip rate to be 0.1% or lower, and another preferred embodiment requires the false defect filtering rate to be 90% or higher, with the predetermined number of consecutive days being four, five, or six days in a row. The qualification condition may include requirements other than those stated above and demand simultaneous satisfaction of two or more requirements; the present invention has no limitation in this regard.

In one preferred embodiment, a criterion for terminating the training procedure is set in case convergence to a desired range cannot be attained after training for a predetermined number of consecutive days. That is to say, the training procedure will be terminated if the predetermined number of consecutive days of training has passed without satisfying the qualification condition. In one preferred embodiment, the predetermined number of consecutive days is five, six, seven, eight, nine, or ten days in a row; the present invention has no limitation in this regard.

The aforementioned test results are detailed below with reference to the accompanying drawings. Please refer first to FIG. 3-1 and FIG. 3-2, which are plots showing the first set of experiment data of the training method of the present invention.

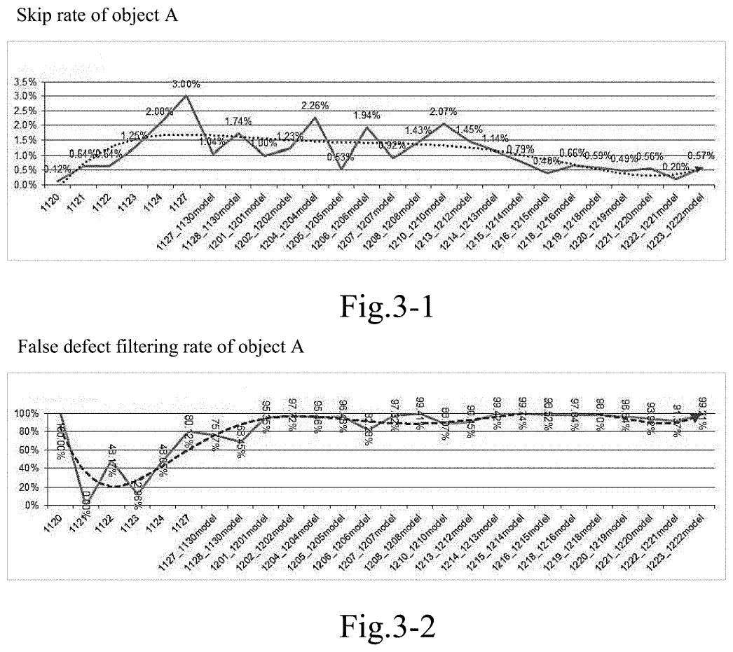

The first set of experiment data is obtained by training with object A. As shown in FIG. 3-1, in which skip rates are plotted against training dates, the skip rates do vary from one training date to another, but the curve showing the overall trend of the skip rates (i.e., the dotted line) reveals that all the skip rates in the latter stage of training are lower than 1%. In particular, the curve section from 1219 model to 1222 model corresponds to four consecutive days for which the skip rates are lower than 0.5%; that is to say, convergence has resulted from the training. Referring to FIG. 3-2, in which false defect filtering rates are plotted against training dates, the false defect filtering rates do vary from one training date to another, but the curve showing the overall trend of the false defect filtering rates (i.e., the dashed line) reveals that all the false defect filtering rates in the latter stage of training are higher than 90%. In particular, the curve section from 1213 model to 1218 model corresponds to five consecutive days for which the false defect filtering rates are higher than 97%, meaning convergence has resulted from the training.

FIG. 4-1 and FIG. 4-2 are plots showing the second set of experiment data of the training method of the present invention.

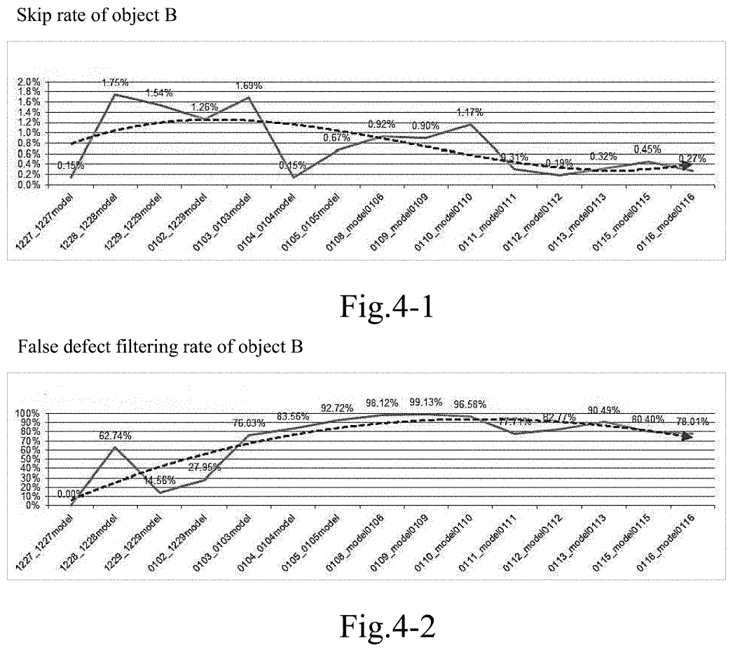

The second set of experiment data is obtained by training with object B. As shown in FIG. 4-1, in which skip rates are plotted against training dates, the curve showing the overall trend of the skip rates (i.e., the dashed line) reveals that the skip rates gradually stabilize. In particular, the curve section from model 0112 to model 0116 corresponds to four consecutive days for which the skip rates are lower than 0.4%; that is to say, convergence has resulted from the training. Referring to FIG. 4-2, in which false defect filtering rates are plotted against training dates, the curve showing the overall trend of the false defect filtering rates (i.e., the dashed line) reveals that the false defect filtering rates gradually stabilize. In particular, the curve section from 0105 model to 0111 model corresponds to five consecutive days for which the false defect filtering rates are higher than 90%, meaning convergence has also resulted from the training. The above experiment data has demonstrated that, when trained with either object by the training method of the present invention, the deep learning system converges significantly in terms of lowering the skip rate and increasing the false defect filtering rates.

As above, the training method of the present invention can be applied as a standard training process for deep learning system, allowing the inspection results generated in the training process to converge, and for the inspection system to have a high identification accuracy rate; furthermore, allowing erroneous classification results to be analyzed with ease, and more specifically, the classification result of each defect is checked against a database to ascertain the cause of any erroneous classification.

The above is the detailed description of the present invention. However, the above is merely the preferred embodiment of the present invention and cannot be the limitation to the implement scope of the present invention, which means the variation and modification according the present invention may still fall into the scope of the invention.

What is claimed is:

1. A training method of an iterative deep learning system, comprising the steps of:
a) providing at least one unlabeled image of an object;
b) labeling the unlabeled image of the object to produce a labeled image of the object;
c) storing the labeled image of the object into an image database if the deep learning system is being trained with a labeled version of the unlabeled image of the object for a first time;
d) identifying the labeled image of the object in the image database and outputting an identification result through the deep learning system and training the deep learning system according to an error between output and expected output of the identification result; and
e) providing another unlabeled image of the object to the trained deep learning system to identify said another unlabeled image of the object and produce an inspection result;
wherein determining whether the inspection result has satisfied a qualification condition and terminating training if the inspection result has satisfied the qualification condition, or repeating the steps a) to e) if the inspection result has not satisfied the qualification condition.

2. The training method of the iterative deep learning system as claimed in claim 1, further comprising the step of transmitting the unlabeled image of the object to a camera, in order for the camera to enhance a defect feature in the unlabeled image of the object.

3. The training method of the iterative deep learning system as claimed in claim 2, further comprising the steps of:
identifying a defect of the object in the unlabeled image of the object by a visual inspector; and
labeling the unlabeled image of the object to indicate a location of the defect identified on the object by a labeling device.

4. The training method of the iterative deep learning system as claimed in claim 3, further comprising the steps of:
normalizing the labeled image of the object by an image processing unit to produce a normalized image; and
storing the normalized image into the image database.

5. The training method of the iterative deep learning system as claimed in claim 1, wherein the training is terminated if the qualification condition is not satisfied after a number of days for which the training is carried out exceeding a predetermined number of days.

6. The training method of the iterative deep learning system as claimed in claim 5, wherein the predetermined number of days is five, six, seven, eight, nine, or ten days.

7. The training method of the iterative deep learning system as claimed in claim 1, wherein the qualification condition is that a false defect filtering rate as well as a skip rate meets a preset standard for a predetermined number of consecutive days.

8. The training method of the iterative deep learning system as claimed in claim 7, wherein the preset standard of the skip rate is 0.1% or lower.

9. The training method of the iterative deep learning system as claimed in claim 7, wherein the preset standard of the false defect filtering rate is 90% or higher.

10. The training method of the iterative deep learning system as claimed in claim 7, wherein the predetermined number of consecutive days is four, five, or six days.

11. The training method of the iterative deep learning system as claimed in claim 1, further comprising the step of storing into the image database a defect image produced by the training, in order for the defect image to serve as a test sample when determining whether another said inspection result has satisfied the qualification condition.

12. The training method of the iterative deep learning system as claimed in claim 1, wherein said determining whether the inspection result has satisfied the qualification condition comprises comparing the inspection result with a determination result of a visual inspector to obtain a skip rate or a false defect filtering rate.

13. An inspection system based on iterative deep learning, comprising:
a labeling device for receiving and then labeling at least one unlabeled image of an object to produce a labeled image of the object;
an image storage unit for storing the labeled image of the object into an image database; and
a processor loaded with a deep learning system and configured to perform the method of claim 1 after loading data from a non-transitory recording medium.

14. The inspection system based on iterative deep learning as claimed in claim 13, further comprising an automated visual inspection device for providing the at least one unlabeled image of the object after identifying a defect of the object.

15. The inspection system based on iterative deep learning as claimed in claim 14, further comprising a camera provided between the automated visual inspection device and the labeling device, wherein the camera is configured to take an image of the object, enhance a defect feature of the object in the image taken, and output a defect-enhanced image to the labeling device.

16. The inspection system based on iterative deep learning as claimed in claim 13, further comprising an image processing unit for producing a normalized image by normalizing the labeled image of the object, and storing the normalized image into the image database.
